(19) United States
(12) Patent Application Publication
(10) Pub. No.: US 2021/0054318 A1
(43) Pub. Date: Feb. 25, 2021

(54) Multi-Use Laundry Balls

(71) Applicant: Henkel IP & Holding GmbH, Duesseldorf (DE)

(72) Inventors: Daniel T. Piorkowski, Fairfield, CT (US); Meghan Russell, Monroe, CT (US); Maxime Pelletier, Sandy Hook, CT (US)

(73) Assignee: Henkel IP & Holding GmbH, Duesseldorf (DE)

(21) Appl. No.: 16/547,548

(22) Filed: Aug. 21, 2019

(51) Int. Cl. C11D 17/04; D06L 1/16

(52) U.S. Cl. CPC C11D 17/046; D06L 1/16

(57) ABSTRACT

Laundry balls and methods of producing and using the same are provided. A laundry ball is provided in an exemplary embodiment. The laundry ball includes a shell that is water permeable, where the shell forms an enclosure defined by an inside of the laundry ball. An insert is enclosed within the enclosure, where the insert includes a laundering beneficial compound.

### FIELD OF THE INVENTION

The technical field relates to laundry balls that can be added to a washing machine and then transferred to a dryer, and more particularly relates to laundry balls with an insert so the laundry ball provides a benefit to both the washing operation and the drying operation.

### BACKGROUND OF THE INVENTION

Garment laundering is a routine task for many households. The process typically includes adding garments to a washing machine, adding detergent and optionally additional washing machine additives to the washing machine, and then washing the garments. The garments are then moved to a dryer, and dryer additives may be added. The garments are dried in the drier, and then optionally sorted, ironed, folded, and prepared for use again. A multitude of different washing machine additives and dryer additives are marketed and sold to consumers, and consumers generally desire products that improve the appearance, feel, and/or smell of the garments or limiting the expense and effort of the laundering process.

Accordingly, it is desirable to provide laundering products that limit the number of products used in the laundry process, and methods of producing the same. In addition, it is desirable to provide laundering products that simplify the laundering process, so that fewer laundry products are used, and methods of producing and using the same. Furthermore, other desirable features and characteristics will become apparent from the subsequent detailed description and the appended claims, taken in conjunction with the accompanying drawings and the foregoing technical field and background.

### BRIEF SUMMARY OF THE INVENTION

Laundry balls and methods of producing and using the same are provided. A laundry ball is provided in an exemplary embodiment. The laundry ball includes a shell that is water permeable, where the shell forms an enclosure defined by an inside of the laundry ball. An insert is enclosed within the enclosure, where the insert includes a laundering beneficial compound. In some embodiments, the insert may be partially exposed outside the ball but not fall out of the ball.

In one embodiment, the laundering beneficial compound is gradually dissolvable when encountered with water such that it provides a benefit in a wash cycle of a washing machine. In another embodiment, the laundering beneficial compound is releasable from the laundry ball upon bouncing movements of the laundry ball bounces such that it provides a benefit in a drying cycle in a dryer machine. The laundering beneficial compound is selected from the group of a fragrance, a dye transfer inhibitor, a chlorine scavenger, and combinations thereof.

In a further embodiment, the laundry ball may comprise an indicator for showing the consumption of the laundering beneficial compound. The indicator may be a color indicator (e.g., blue color) located on the surface of the ball or on the insert. When the indicator is on the insert, a window or small opening on the ball is provided to allow consumers to see the color indicator, with each wash and/or drying, the color strength or fullness reduces. Upon noticing the complete depletion of the color, a consumer would thus know to use a new laundry ball with a new insert, or remove a residual insert and refill a new insert into the laundry ball. For example, if it is determined that a brand new laundry beneficial compound or insert may be used in 5 wash/drying cycles based on prior study or calculation of their solubilities, etc., a color indicator on the ball may be configured to completely lose its original color in 5 wash/drying cycles. Having a color indicator to guide consumers about consumption of a laundering beneficial compound in an insert is helpful, particularly if the insert has a carrier which is not water soluble, in which case the insert might still physically not change in shape or size even after all of the laundering beneficial compound has been consumed.

In one embodiment, there is no color indictor; however, the insert is visible from the ball, either through a window or an opening on the ball. In this embodiment, the insert is slowly dissolved or otherwise consumed upon each wash and/or drying. Upon noticing the disappearance of the insert, a consumer would know to use a new laundry ball with a new insert or refill a new insert into the laundry ball.

A method for laundering a garment with a laundry ball is provided in another embodiment. The method includes adding the laundry ball, as described earlier, and the garment to a washing machine, where the laundry ball comprises a laundering beneficial compound that provides a benefit in the washing machine. The garment and laundry ball are washed in a wash cycle of the washing machine, and then both are transferred to a dryer, and dried in the dryer, where the laundry ball provides a benefit in the dryer.

A method of producing a laundry ball is provided in yet another embodiment. The method includes forming an insert having a water solubility of from about 0.005 grams per liter of water to about 0.25 grams per liter of water at a temperature of about 20 degrees Celsius, and where the insert includes a laundering beneficial compound. The insert is placed within an enclosure of a shell, where the shell is porous, and the insert is sealed within the enclosure to form the laundry ball.

### BRIEF DESCRIPTION OF THE DRAWING

The present embodiments will hereinafter be described in conjunction with the following drawing figure, wherein:

FIG. 1 is a perspective view of an embodiment of a laundry ball.

### DETAILED DESCRIPTION OF THE INVENTION

The following detailed description is merely exemplary in nature and is not intended to limit the product described, or the method for producing or using the same. Furthermore, there is no intention to be bound by any theory presented in the preceding background or the following detailed description.

The term “about” as used in connection with a numerical value throughout the specification and the claims denotes an interval of accuracy, familiar and acceptable to a person skilled in the art. In general, such interval of accuracy is ±10%. Thus, “about ten” means 9 to 11. All numbers in this description indicating amounts, ratios of materials, physical properties of materials, and/or use are to be understood as modified by the word “about,” except as otherwise explicitly indicated.

A laundry ball includes a shell that forms an enclosure, and an insert is disposed within the enclosure. The insert comprises one or more laundering beneficial compounds that are adapted to improve garment laundering operations, including washing and drying operations. The laundry ball serves as a mechanical aid in a reduction of time for the garments to dry in a dryer. As such, the laundry ball serves a dual function as an aid in the washing process and also as an aid in the drying process.

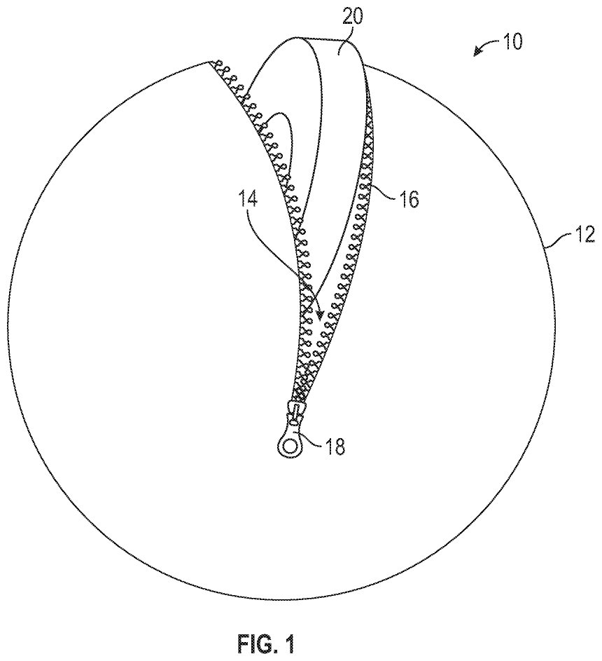

Reference is made to FIG. 1. A laundry ball 10 includes a shell 12 that forms an enclosure 14 defined by an inside of the shell 12 of the laundry ball 10. The shell 12 is water permeable, or porous, such that water can flow through the shell 12, but objects larger than the size of the pores cannot flow through the shell 12. The shell 12 may be made of a fabric, such as wool, cotton, polyester, silk, or other materials or combinations of materials in various embodiments. The pores are then the spaces that are disposed between and defined by the threads of the fabric. In an alternate embodiment, the shell 12 may be polymeric, and include a polymer such as a polyethylene, polypropylene, polyethylene-polypropylene co-polymers, or other polymers. The shell 12 may be a combination of different materials in some embodiments, such as a fabric wrapped over a polymeric base, in whole or in part, or different types of materials woven together or positioned in different locations on the shell 12. The shell 12 may include rubber, wood, or other materials in various embodiments. In an exemplary embodiment, the shell 12 is soft, flexible, and resilient, such as a fabric, so the laundry ball 10 will not make excessive noise in a dryer. In an exemplary embodiment, the shell 12 is primarily a fabric, where the term “primarily,” as used herein, means the named component comprises more than about 50 weight percent of the article, based on a total weight of the article. The shell 12 forms the outer portion of the laundry ball 10 in an exemplary embodiment, so the outer dimensions of the shell 12 also essentially determine the outer dimensions of the laundry ball 10.

The laundry ball 10 may be spherical in an exemplary embodiment, but the laundry ball 10 may have a wide variety of other shapes in alternate embodiments. For example, the laundry ball 10 and shell 12 may be cubical, oblong, egg shaped, pyramidal, or almost any other shape as long as there are no sharp edges. The laundry ball 10 may be from about 3 centimeters (cm) to about 40 cm across, where the distance is measured directly across the largest portion of the laundry ball 10. In alternate embodiments the laundry ball 10 may be from about 4 cm to about 30 cm, or from about 4.5 cm to about 15 cm, again measured across the largest portion of the laundry ball 10.

The shell 12 includes a shell opening 16 in an exemplary embodiment, where the shell opening 16 provides access to an enclosure 14 defined within the shell 12. As such, the enclosure 14 is defined by an inside of the shell 12 and the laundry ball 10. The shell opening 16 is sealable, such that the shell opening 16 can be shut to prevent objects in the enclosure 14 from falling out. In an exemplary embodiment, the shell opening 16 is resealable, such that the shell opening 16 can be repeatedly opened and sealed. In an exemplary embodiment, the shell opening 16 is resealable with a resealable fastener 18, such as a zipper (as illustrated in FIG. 1), hook and loop connections, laces, or other devices configured to reversibly close and seal the shell opening 16. In an alternate embodiment, the shell opening 16 is permanently sealed shut, such as by being sewed shut, glued shut, heat sealed shut, or otherwise sealed shut. The shell opening 16 may be from about 2 to about 40 cm across in an exemplary embodiment, but in alternate embodiments the shell opening 16 may be from about 3 to about 30 cm across, or from about 3.5 to about 15 cm across.

The laundry ball 10 also includes an insert 20 enclosed within the enclosure 14. The insert 20 is a solid, and may be a wide variety of shapes. In an exemplary embodiment, the insert 20 is a cylinder, such as a disk shape, but the insert 20 may be spherical, cubical, pyramidal, or almost any other shape as long as there are no sharp edges. The insert 20 is sized to fit within the enclosure 14, so the insert 20 is smaller across than the distance across the laundry ball 10 and shell 12, as measured directly across the largest dimension of the insert 20 and the laundry ball 10. The insert 20 may be a one single solid object, as illustrated in FIG. 1, but in alternate embodiments the insert 20 may include granules, pastilles, or another collection of a plurality of distinct different solid objects. The distance across the insert 20, or any solid portion of the insert 20 for embodiments with a plurality of distinct different solid objects, is greater than the pore size of the shell 12. As such, the insert 20 is encased within the enclosure 14 and cannot fall out when the shell opening 16 is sealed shut.

The insert 20 is configured to gradually dissolve in a wash cycle of a washing machine, and the shell 12 is configured not to dissolve in water. As such, the shell 12 is non-water soluble, and may have a water solubility of about 0.0001 grams per liter of water or less at 20 degrees Celsius (° C.). The insert 20 is configured to pass through a plurality of wash cycles before completely dissolving. In an exemplary embodiment, the insert 20 is configured to dissolve in from about 2 to about 50 wash cycles in a standard washing machine, but the rate of dissolution depends on the wash temperature, the amount of water used in the wash cycle, and other factors. A typical wash cycle may use from about 20 to about 200 liters of water, but other amounts may also be used. As such, the insert 20 is configured to have a limited solubility in water. The solubility is dependent on temperature, but the solubility described here is at a temperature of about 20° C. It is understood that the solubility values will vary with different temperatures.

The insert 20 includes a laundering beneficial compound that imparts a desirable trait or benefit to a garment during the wash cycle, the drying cycle, or both the wash and drying cycle. The term “garment,” as used herein, includes cloths, sheets, towels, blankets, and other products primarily made of fabric. As such, the term “garment” is not limited to clothing items for this description. The laundering beneficial compound may be included in the insert 20 in an amount of from about 0.1 to about 50 weight percent, based on a total weight of the insert 20, but in alternate embodiments the laundering beneficial compound may be included in the insert 20 in an amount of from about 0.5 to about 30 weight percent, or from about 1 to about 20 weight percent, or from about 3 to about 10 weight percent, all based on a total weight of the insert 20.

In an exemplary embodiment, the insert 20 has a water solubility of from about 0.005 grams per liter of water to about 0.25 grams per liter of water, at a temperature of about 20° C., and where the referenced water is distilled. In alternate embodiments, the insert 20 has a water solubility of from about 0.01 to about 0.2 grams per liter of water, or from about 0.5 to about 0.1 grams per liter of water, again at a temperature of about 20° C. The solubility is set so the insert 20 will gradually dissolve and release its contents into the wash water, but so the laundry ball 10 with the insert 20 can be reused for a plurality of wash cycles. As such, the insert 20 has some solubility in water, but not too much, so the solubility of the insert 20 falls within the specified ranges. Too high of a solubility will cause the insert 20 to dissolve before finishing a wash cycle, and too low of a solubility will cause not enough material from the insert 20 to be discharged into the wash water. In an alternate embodiment, the insert 20 may have a higher solubility in water, but a solubility rate may be set such that the insert 20 survives a plurality of wash cycles. For example, the insert 20 may have a solubility rate of about 1 to about 15 grams in 30 minutes, where the solubility rate is measured for an insert 20 with an insert surface are of about 70 cm, in 20 liters of distilled water at 25° C., with constant agitation. In alternate embodiments, the insert has a solubility rate of from about 1 to about 10 grams in 30 minutes, or about 1 to about 5 grams in 30 minutes, at the same conditions as described above.

The insert 20 has a melting point that is at least greater than the temperature typically utilized in a drying cycle of a dryer, so the insert 20 can survive the drying cycle. In some embodiments, one or more components from the insert 20 may be transferred to garments in drying process. Portions of the insert 20 may break or chip off, and may thereby pass through the wall of the shell 12 and onto the garments being laundered. Also, the garments are typically wet when added to the dryer, and this residual water from the washing machine may dissolve and transfer some material from the insert 20 to the garments, such as the laundering beneficial compound. As such, the laundering beneficial compound may be added to the garments being laundered in the washing machine, the dryer, or in both the washing machine and the dryer. In some embodiments, the insert 20 substantially passes through a drying cycle unchanged. For example, the insert 20 may pass through a drying cycle with a weight loss of about 20 percent or less, based on a weight of the insert 20 at the beginning of the drying cycle. However, in alternate embodiments, the insert 20 passes through a drying cycle with a weight loss of about 10 percent or less, or a weight loss of about 5 percent or less, or a weight loss of about 2 percent or less, all based on the weight of the insert 20 at the beginning of the drying cycle. To survive the drying cycle, the insert 20 may have a melting point that is about 80° C. or greater, such as from about 80 to about 1,000° C., or from about 80 to about 500° C., or from about 80 to about 200° C. in various embodiments.

The laundering beneficial compound may include one or more of a fragrance, a dye transfer inhibitor, a chlorine scavenger, or other materials in various embodiments. The fragrance may be an encapsulated fragrance, or a combination of an encapsulated fragrance and fragrance that is not encapsulated, or just a fragrance that is not encapsulated. Encapsulation of fragrances prevents the fragrance from being released prematurely. The encapsulation may be ruptured at some time period after application to the garment, so fresh fragrance may be provided significantly after a garment is removed from a washing machine. The encapsulation may be ruptured by a wide variety of activities, such as physical contact from movement, melting, degradation from sunlight, degradation from oxidation, or other reasons. The encapsulation may be formed by aminoplast or cross-linked gelatin, polymeric materials, or other materials. The fragrance may be neat oil fragrance, an essential oil, botanical extracts, synthetic fragrance materials, or other compounds that provide a desirable odor.

A dye transfer inhibitor is a compound that impedes, slows, or stops the transfer of a dye from one garment to another in a wash cycle. Dye transfer inhibitors may include, but are not limited to, one or more of polymers containing vinylamine units, quaternized dye scavengers that are supported on cellulosic substrates, polyvinyl pyrrolidone, polyvinyl alcohol (PVA), polyamine-N-oxides, cationic starches, polyethylene imines, polyvinyl oxazolidone, enzymatic systems, polyvinylimidazole, polyvinylpyrrolidone-polyvinylimidazole co-polymers, and others.

A chlorine scavenger reacts or binds with free chlorine that may be present in chlorinated water, such as the water provided by many municipalities. Exemplary chlorine scavengers include, but are not limited to, strontium nitrate, barium nitrate, potassium nitrate, lithium carbonate, certain amines, ammonium salts, certain amino acids, polyamino acids, polyethyleneimines, select polyamines, polyamine amides, polyacrylamides, triethanolamine, diethanolamine, and monoethanolamine.

The laundering beneficial compound may be a solid, a liquid, or a combination thereof in certain embodiments. However, the laundering beneficial compound is combined with a carrier, where the carrier may be selected to provide the desired water solubility and melting point for the insert 20, as described above. The carrier may be polymeric in an exemplary embodiment, and the type of polymer and the molecular weight of the polymer may be selected to provide the desired water solubility and melting point. Therefore, the carrier may have a melting point that is about the same as the melting point of the insert 20, such as a melting point of at least 50° C. or higher, or from about 60 to about 1,000° C., or from about 70 to about 500° C., or from about 80 to about 200° C. in various embodiments. In a similar manner, the carrier may have a water solubility that is about the same as the insert 20, such as a water solubility of from about 0.005 grams per liter of water to about 0.25 grams per liter of water, or from about 0.01 to about 0.2 grams per liter of water, or from about 0.5 to about 0.1 grams per liter of water, again at a temperature of about 20° C. Other possible carriers may include, but are not limited to, selected gelatins or chitosans. The insert 20 may include the carrier in an amount of from about 50 to about 99.9 weight percent in an exemplary embodiment, but the inset 20 may include the carrier in an amount of from about 70 to about 99.5 weight percent, of from about 80 to about 99 weight percent, or from about 90 to about 97 weight percent in various embodiments, all based on the total weight of the insert 20. The insert 20 may also include other optional materials in some embodiments, such as a colorant, a filler, or other materials at from about 0 to about 20 weight percent, based on a total weight of the insert 20.

Some exemplary polymers that may be utilized for the carrier include, but are not limited to, one or more of a polyethylene glycol (also known as polyethylene oxide,) an ethylene oxide/propylene oxide poloxamer, sodium acetate, potassium acetate, sodium and potassium acetate, an ethylene oxide/propylene oxide/ethylene oxide poloxamer; and a propylene oxide/ethylene oxide/propylene oxide poloxamer. The insert may be formed by melting the carrier, combining the laundering beneficial compound and any other materials that may be included in the insert 20 with the molten carrier, pouring the combination of the carrier and other materials into a mold, and then solidifying the carrier in the shape of the mold with the laundering beneficial compounds and other materials that may be present intermixed therein. As the carrier dissolves, the laundering beneficial compound within the insert 20 is released into the wash water. This provides a benefit to the garments in the wash cycle, as previously described.

The present disclosure also includes a method of producing a laundry ball 10 and a method of using the laundry ball 10. The laundry ball 10 may be produced by forming the insert 20 with the carrier and the laundering beneficial compound, as described above, and inserting the insert 20 into the enclosure 14 of the shell 12 through the shell opening 16, again as described above. The shell opening 16 may then be sealed shut to retain the insert 20 within the enclosure 14.

The laundry ball 10 may be utilized by adding the laundry ball 10 to a washing machine prior to washing a garment, where the laundry ball 10 includes the insert 20 with the laundering beneficial compound as described above. The garment and laundry ball 10 then pass through a wash cycle in the washing machine, and then the laundry ball 10 and garment are transferred to a dryer. The garment and laundry ball 10 then pass through a drying cycle in the dryer. The laundry ball 10 may provide a physical benefit in the dryer by reducing or preventing the garment from “clumping” in the dryer. The laundry ball 10 may also retain heat that is transferred to the garment, which may aid in the drying process. Some garments, such as towels, sheets, blankets, and other large fabric garments, may tend to clump or wad together in a dryer such that the portion of the garment that is near the center of the clump is shielded from the agitation and heat provided by the dryer. The laundry ball 10 may help reduce this clumping effect by penetrating between the folds of the garment(s) and helping to separate these folds so hot drying air can more readily reach different parts of the garment. As such, the laundry ball 10 provides a benefit in both the wash cycle of the washing machine and the drying cycle of the dryer. Furthermore, the laundry ball 10 is included with the garment in both the wash cycle and the drying cycle.

### EXAMPLES

The following examples are exemplary in nature, and provide at least one example of various aspects of the laundry ball 10.

### Example 1

### Insert Production

An exemplary insert is formed by heating polyethylene glycol to a molten state, and then adding fragrance to the molten polyethylene glycol. The polyethylene glycol serves as the carrier for the insert, and the different types of fragrance serve as the laundering beneficial compounds. Table 1 below details the components and weight percentages used in the exemplary insert, where all weights percentages are based on a total weight of the insert.

TABLE 1

| | Description | Weight percent |
|---|---|---|
| Polyethylene | Weight average molecular weight | 95 |
| glycol 8,000 | of about 8,000 Daltons | |
| Encapsulated | Approx. 30% active encapsulated | 2 |
| fragrance | fragrance, 70% water. | |
| Fragrance oil | Neat oil fragrance | 3 |

The insert described above was utilized with a detergent composition, where the detergent composition was added to a washing machine separately with the laundry ball including the insert. The detergent composition included the material listed in Table 2, where all components are listed as weight percent, based on a total weight of the detergent composition.

TABLE 2

| Compound | Weight percent |
|---|---|
| Glycerin | 11.795 |
| Alcohol ethoxylate surfactant | 23.074 |
| Propylene glycol | 8.206 |
| Monoethanol amine | 3.15 |
| water | 4.567 |
| Linear alkylbenzene sulfonic acid surfactant | 5.0 |
| Coconut oil fatty acid | 10.0 |
| Alcohol ethoxysulfate surfactant | 26.0 |
| Bittering agent | 0.05 |
| Detergent enzyme | 0.625 |
| Optical brightener | 0.2 |
| Ethoxylated polyethyleneimine detergent surfactant | 6.0 |
| Sodium sulfite (15% active solution in water) | 1.33 |

### Example 2

### Laundry Ball Production

A laundry ball shell was sewn into a ball-shaped shell using wool fabric. The shell was cut open, and an insert as formed in Table 1 was inserted inside the shell. The insert weighed 28.5 grams, and was in the shape of a disc. The opening of the shell was then sewn shut with the insert inside.

### Example 3

### Laundry Ball Use

The laundry ball from Example 2 was used in an exemplary laundering process. The laundry ball was added to a washing machine with 20 grams of the detergent composition from Table 2, approximately 2,700 grams of ballast, and 5 terrycloth towels. The washing machine was run using water at about 32 degrees Celsius (° C.), 120 parts per million (PPM) of water hardness, and no chlorine for a standard washing machine cycle. The laundry ball, the ballast, the terrycloth towels, and residual washing water were added to a standard dryer and dried for 90 minutes on the low heat option.

The insert had an initial weight of 28.5 grams, as mentioned above. After 1 wash cycle as described above, the insert had a weight of 22.83 grams. This is about a 20% reduction ((28.5 grams-22.83 grams) divided by 28.5 grams.) After 1 drying cycle, as described above, the insert had a weight of 21.82 grams. This is about a 4.4% reduction ((22.82-21.82) divided by 22.82).

### Example 4

### Evaluation

The terrycloth towels were then evaluated for fragrance. The fragrance evaluation is performed by human panelists. After the terrycloth towels are washed and then machine dried, each panelist receives a terrycloth towel to perform a sensory evaluation for the strength of the fragrance. The scoring system is 0 to 10, with a 0 being no fragrance and a 10 being a maximum amount of fragrance. This score is only fragrance intensity and does not include any degree of liking. Any score over 0 signifies that fragrance has been deposited onto the fabric and is perceptible by the panelist. The scores from the panelists were 3, 4, 5, 2, and 4, for an average result of 3.6. The fragrance evaluation demonstrates the effectiveness of the laundry ball for depositing fragrance. Fragrance is one example of a beneficial laundry aspect that may be incorporated into the laundry ball and transferred to garments in the laundering process.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A laundry ball comprising:
a shell, wherein the shell is water permeable, and where the shell forms an enclosure defined by an inside of the laundry ball; and
an insert enclosed within the enclosure, wherein the insert comprises a laundering beneficial compound;
wherein the laundering beneficial compound is gradually dissolvable when encountered with water such that it provides a benefit in a wash cycle of a washing machine.

2. The laundry ball of claim 1, wherein the laundering beneficial compound is selected from the group of a fragrance, a dye transfer inhibitor, a chlorine scavenger, and combinations thereof.

3. The laundry ball of claim 1, wherein the laundering beneficial compound is releasable from the laundry ball upon bouncing movements of the laundry ball bounces such that it provides a benefit in a drying cycle in a dryer machine.

4. The laundry ball of claim 3, wherein the laundering beneficial compound is a fragrance.

5. The laundry ball of claim 1, further comprising an indicator on the laundry ball for showing the consumption of the laundering beneficial compound.

6. The laundry ball of claim 1, wherein the insert is one solid object, and wherein the insert has a melting point of from about 70 degrees to about 500 degrees Celsius.

7. The laundry ball of claim 1, wherein the shell comprises a shell opening, wherein the laundry ball further comprises a resealable fastener configured to close the shell opening.

8. The laundry ball of claim 7, wherein the resealable fastener is a zipper.

9. The laundry ball of claim 1, wherein the shell primarily comprises a fabric.

10. The laundry ball of claim 1, wherein the insert comprises a polymer.

11. The laundry ball of claim 10, wherein the polymer comprises one or more of a polyethylene oxide, an ethylene oxide/propylene oxide poloxamer, an ethylene oxide/propylene oxide/ethylene oxide poloxamer; sodium acetate, potassium acetate, and a propylene oxide/ethylene oxide/propylene oxide poloxamer.

12. The laundry ball of claim 1, wherein the insert has a water solubility of from about 0.005 grams per liter of water to about 0.25 grams per liter of water at a temperature of about 20 degrees Celsius.

13. The laundry ball of claim 1, wherein the insert has a water solubility of from about 0.01 grams per liter of water to about 0.2 grams per liter of water at a temperature of about 20 degrees Celsius.

14. The laundry ball of claim 1, wherein the insert comprises the laundering beneficial compound combined with a carrier, wherein the carrier comprises a polymer.

15. The laundry ball of claim 14, wherein the polymer has a melting point of at least about 80 degrees Celsius, and wherein the polymer has a water solubility of from about 0.005 grams per liter of water to about 0.25 grams per liter of water at a temperature of about 20 degrees Celsius.

16. The laundry ball of claim 14, wherein the polymer has a melting point of from about 50 degrees Celsius or higher, and wherein the polymer has a water solubility of from about 0.01 grams per liter of water to about 0.2 grams per liter of water at a temperature of about 20 degrees Celsius.

17. The laundry ball of claim 1, wherein the laundry ball is from about 5 centimeters to about 30 centimeters across, measured across a largest portion of the laundry ball.

18. A method for laundering a garment comprising the steps of:
(1) adding a laundry ball and the garment to a washing machine,
wherein the laundry ball comprises:
a shell, wherein the shell is water permeable, and where the shell forms an enclosure defined by an inside of the laundry ball; and
an insert enclosed within the enclosure, wherein the insert comprises a laundering beneficial compound that is water-soluble and releasable from the laundry ball with agitation of the laundry ball;
(2) washing the garment and the laundry ball in a wash cycle of the washing machine;
wherein the laundering beneficial compound is gradually dissolved when encountered with water in a wash cycle of a washing machine to release laundering beneficial during the wash cycle;
(3) washing the garment and the laundry ball in a wash cycle of the washing machine;
(4) transferring the garment and the laundry ball into a dryer; and
(5) drying the garment with the laundry ball in a dryer,
wherein the laundering beneficial compound is released from the laundry ball onto the garment upon bouncing movements of the laundry ball bounces in a drying cycle.

19. The method for laundering a garment of claim 18, wherein the laundering beneficial compound comprises a fragrance.

20. A method of producing a laundry ball comprising:
forming an insert having a water solubility of from about 0.005 grams per liter of water to about 0.25 grams per liter of water at a temperature of about 20 degrees Celsius, and wherein the insert comprises a laundering beneficial compound;
placing the insert within an enclosure of a shell, wherein the shell is porous; and
sealing the insert within the enclosure to form the laundry ball.
